(19) United States
(12) Patent Application Publication
(10) Pub. No.: US 2005/0149751 A1
(43) Pub. Date: Jul. 7, 2005

(54) Contents delivery method, contents delivery system, electronic device terminal, and contents delivery server

(76) Inventors: Makoto Ochi, Hirakata City (JP); Hirokazu So, Moriguchi City (JP); Shinji Inoue, Neyagawa City (JP)

Correspondence Address: SMITH PATENT OFFICE, 1901 PENNSYLVANIA AVENUE N W, SUITE 200, WASHINGTON, DC, 20006, US

(21) Appl. No.: 11/010,650

(22) Filed: Dec. 14, 2004

(30) Foreign Application Priority Data
Dec. 15, 2003 (JP) 2003-416300

(51) Int. Cl. H04L 9/00

(52) U.S. Cl. 713/200

(57) ABSTRACT

Rights information concerning contents required by a user terminal and these contents are delivered via a data communication network from a contents provider having a contents delivery server. The user terminal overwrites rights information stored in an information memory within or attached to the terminal with rights information that is newly delivered from the contents delivery server. A variety of contents services are provided to users free of charge or at discounted rates on the condition that rights information is overwritten in this manner.

### BACKGROUND OF THE INVENTION

1. Field of the Invention

The present invention relates to a contents delivery method, a contents delivery system, an electronic device terminal and a contents delivery server, wherein a variety of digital contents and rights information attached thereto are delivered to a user's terminal via a communication network which is either wired or wireless.

2. Discussion of the Related Art

Music data is delivered by utilizing a personal computer (PC) that is connected to the internet. In addition, various communications companies deliver a variety of contents such as music, video, books and other applications (for example, videogames) to cellular phones and Personal Handy-phone System (PHS) phones. Such delivery of a variety of contents via wired and wireless communication networks is likely to be more widely used in the future. In such delivery of contents, contents are delivered as digital data; therefore, the problem of copyright infringement resulting from illegal copying arises, particularly with copyrighted contents such as music, video, books and other applications (for example, videogames).

In order to implement contents delivery that deals with the above problem, the following system, for example, is used in delivery of music contents. A user receives delivery of music contents from a contents provider by utilizing specific software. A module that has been made tamper resistant according to a technology for preventing illegal altering on a PC has been integrated into this specific software. At this time, the user receives rights information that includes contents and conditions of use for the contents via a secure path on which encryption processing and the like have been carried out. The received contents and rights information are stored in a hard disk within a PC in such a condition as to prevent illegal copying. The user pays a price of the contents that have been delivered in such a manner to the contents provider via settlement by credit card or the like.

In addition, the contents and the rights information that have been stored in the hard disk within the PC can further be written into a semiconductor decoding medium that has a high-level copyright protection function. The contents can be written into an information recording medium such as a Secure Digital (SD) memory card, mini SD memory card or the like using specific software, so that it has become possible to freely carry around the recording medium and to reproduce the contents with a portable music player while protecting the copyright of the contents.

In the delivery of contents, such as music contents, a business model where a price is paid only for the data that is the contents is generally used. In the contents delivery, no ROM medium is sold, unlike with the sale of CDs and DVDs in stores. Therefore, the user may simply erase the data of the contents that has become unnecessary, and it is not necessary to discard an information recording medium such as a CD or a DVD. That is, when a user is in an environment that allows for the reception of contents delivery, contents are easily available when necessary, and the contents can easily be discarded as soon as they have become unnecessary.

On the other hand, in a case a user purchases a medium such as a CD or a DVD in which contents are stored at a store or the like, the user can sell the information recording medium together with the contents by taking the information recording medium to a second hand store when it has become unnecessary. That is, the user can receive the price of the contents that have become unnecessary by selling the used medium. In contrast, a system that allows only the digital data which has been delivered through contents delivery to be sold is not generally used.

Concerning such a problem, for example, JP-A 2002-123700 proposes a data rights purchasing/selling device (hereinafter referred to as “refunding device”). Here, a user inserts an information recording medium, in which rights information and contents have been stored, into a refunding device, and can receive a refund for deleted rights information by deleting the rights information and the contents.

In a case a refunding device for deleting rights information of digital data is installed, it becomes possible to receive a refund for the acquired contents and rights information in the same manner as in a case of repayment by taking a medium such as a CD or DVD in which contents have been stored to a second hand store. In such a refund method, however, the conventional service that is provided to a user at the time of purchase of a CD or DVD in which contents have been stored is merely provided by using a device. In this system, a method for supplying a service that takes advantage of characteristics of delivery method of digital data with rights information, that is, a more flexible service that is useful for the user or the contents delivery service provider and which does not exist in the conventional method of selling a CD or DVD is not implemented.

### SUMMARY OF THE INVENTION

The present invention has been made in view of the above conventional problems, and an object of the invention is to provide a variety of contents services to a user at a discount rate under a condition that a function of overwriting existing rights information with new rights information is provided to a user terminal, so that rights information on contents which are storable can be controlled when rights information is overwritten.

A contents delivery system of the present invention includes a contents delivery server which delivers contents which are made up of digital data, a data communication network which transmits/receives data by using a communication line which is either wired or wireless, and an electronic device terminal having a function of storing contents and a function of storing rights information that includes information on restriction of use of contents or an encryption key for the contents.

Rights information and contents are delivered to the electronic device terminal via the communication network from the contents delivery server in response to a contents delivery request from the electronic device terminal under a condition of fee imposition. The system has a feature in that the electronic device terminal receives the contents free of charge or at a discount rate under a condition that the rights information that is stored in an information recording medium in or attached to the electronic device terminal is overwritten with newly delivered rights information.

### BRIEF DESCRIPTION OF THE DRAWINGS

FIGS. 1A and 1B are diagrams showing an entire configuration of a contents delivery system according to a first embodiment of the present invention;

FIG. 2 is a diagram showing a delivery history according to the first embodiment of the present invention;

FIGS. 3A and 3B are diagrams each showing a configuration of rights information according to the first embodiment of the present invention;

FIG. 4 is a diagram showing a first example of fee imposition processing in the contents delivery system according to the first embodiment of the present invention;

FIG. 5 is a diagram showing a second example of fee imposition processing in the contents delivery system according to the first embodiment of the present invention;

FIG. 6 is a diagram illustrating a processing sequence on a server side and on a user terminal side in the contents delivery system according to the first embodiment of the present invention;

FIG. 7 is a flowchart showing a processing procedure in the contents delivery server according to the first embodiment of the present invention;

FIG. 8 is a first flowchart showing a processing procedure of a terminal according to the first embodiment of the present invention;

FIG. 9 is a second flowchart showing the processing procedure of the terminal according to the first embodiment of the invention;

FIGS. 10A to 10D are diagrams each illustrating an example of displays on a terminal according to the first embodiment of the present invention;

FIG. 11 is a diagram illustrating a processing sequence on a server side and on a user terminal side in a contents delivery system according to a second embodiment of the present invention;

FIG. 12 is a flowchart showing a processing procedure of a contents delivery server according to the second embodiment of the present invention;

FIG. 13 is a first flowchart showing a processing procedure of a terminal according to the second embodiment of the present invention;

FIG. 14 is a second flowchart showing the processing procedure of the terminal according to the second embodiment of the present invention;

FIG. 15 is a third flowchart showing the processing procedure of the terminal according to the second embodiment of the present invention;

FIGS. 16A to 16C are diagrams each illustrating a first example of displays on a terminal according to the second embodiment of the present invention;

FIGS. 17A to 17C are diagrams each illustrating a second example of displays on the terminal according to the second embodiment of the present invention; and

FIG. 18 is a diagram illustrating a delivery history according to the second embodiment of the present invention.

### DESCRIPTION OF THE PREFERRED EMBODIMENTS

In the following, embodiments of the present invention will be described with reference to the drawings; however, the technical scope of the present invention is not limited thereto.

### First Embodiment

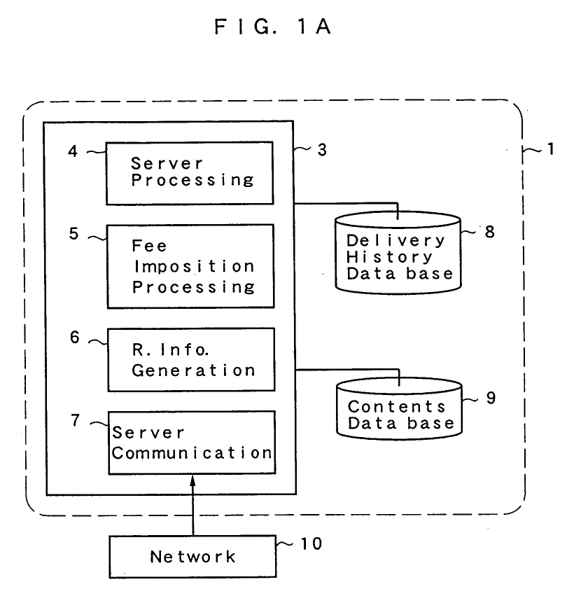

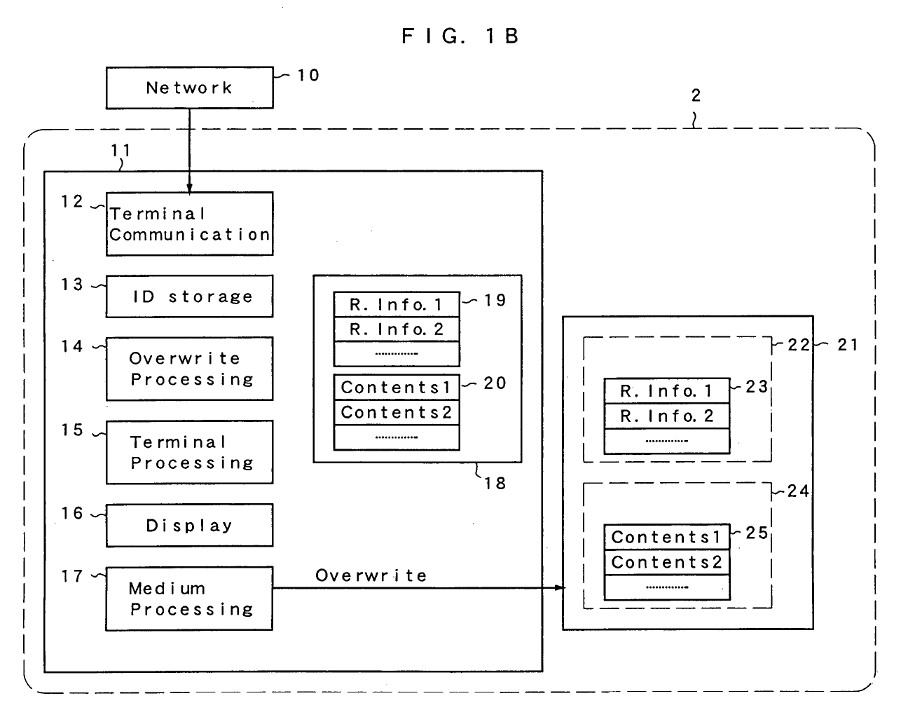

FIGS. 1A and 1B are diagrams showing an entire configuration of a contents delivery system according to a first embodiment of the present invention. The contents delivery system has a configuration in that a contents provider 1 delivers contents to a user 2 via a data communication network 10 in response to a request from the user 2. The contents provider 1 includes a contents delivery server 3, a delivery history database 8 and a contents database 9.

The contents delivery server 3 includes a server central processing part 4, a fee imposition information processing part 5, a rights information generation part 6 and a server communication processing part 7. The fee imposition information processing part 5 calculates a price of contents that have been delivered to the user 2. The rights information generation part 6 generates contents information and information on matters of restriction of use on each part of the contents when the contents are delivered to the user 2. The server communication processing part 7 is connected to the data communication network 10. The server central processing part 4 controls respective functions of the server central processing part 4, the fee imposition information processing part 5, the rights information generation part 6 and the server communication processing part 7.

The delivery history database 8 is a database for managing information such as information of the respective users 2, information on the delivery history of the contents, and fee imposition information. The contents database 9 stores digital data which is formed of contents such as music data, moving image data, document data (book contents) and application software (game contents). These contents may be data prepared by the contents provider 1 or may be digital data which has been purchased from another contents preparation company and which has been made for delivery.

The data communication network 10 is the internet network having a wired or wireless configuration or a communication network provided by respective companies that conduct cellular phone or PHS business. The user 2 stores the contents that have been delivered to a user terminal 11 or an information recording medium that can be mounted on the user terminal 11. Here, the user terminal 11 is referred to as electronic device terminal of the present invention.

The user terminal 11 includes a mobile device such as a personal digital assistants (PDA), a cellular phone, a PHS and a personal computer. The user terminal 11 has a terminal communication processing part 12, a terminal ID storage part 13, a rights information overwriting processing part 14, a terminal central processing part 15, a display part 16, an information recording medium processing part 17, and an internal memory or a hard disk as an information recording region 18.

The terminal communication processing part 12 is a processing part for the connection to the data communication network 10. The terminal ID storage part 13 stores an ID particular to the user terminal, for example, an arbitrary value, or a telephone number in a case the terminal is a cellular phone or a PHS. The rights information overwriting processing part 14 (hereinafter referred to as overwriting processing part 14) searches existing rights information and carries out overwriting processing on the existing rights information when the delivered contents are written. The medium which the contents are written is the information recording region 18 of the internal memory or an information recording medium 21, an external memory, which is attachable to and removable from the terminal body. The display part 16 displays a variety of information. The information recording medium processing part 17 (hereinafter referred to as medium processing part 17) carries out a specific processing procedure on an information recording medium that has a copyright protection function, in order to write the delivered contents and rights information into the information recording medium 21. The information recording region 18 is a memory or a hard disk that can store the delivered contents and the rights information on the contents, wherein these are referred to as internal memories. The terminal central processing part 15 is a central processing part for controlling the respective functions of the user terminal 11.

Here, overwriting of rights information will be described. Overwriting of rights information means to overwrite a variety of rights information on the corresponding contents with some other information. Information to be overwritten may be, for example, a random number, new rights information or partial information that is included in rights information. Information on restriction of use may be partial information of rights information. This may relate to the number of copies of the contents to be copied, the number of movements of a recording region being moved or the like. In addition, other rights information includes information that can uniquely identify a contents delivery service provider, and information on the time and date (setting time) when a discount rate is applied.

In this embodiment, a variety of contents having copyright are processed so as to be, for example, encrypted or restricted or controlled in their use in accordance with each piece of rights information that corresponds to each part of the contents. Therefore, handling of the contents, such as reproduction or moving, by an electronic device terminal complies with rights information. As a result of this, the handling method is controlled in such a manner that the contents of which only rights information has been overwritten become non-reproducible in the electronic device terminal. On the other hand, as for the overwriting of existing rights information and existing contents with newly delivered rights information and contents, it becomes possible to replace rights information and contents with new rights information and contents having the same size using the same amount of the memory region.

Here, as for the overwriting of rights information and contents, for example, existing rights information and contents are once deleted and, after that, new rights information and contents are stored. Consequently, rights information and contents can be overwritten (or replaced) in an electronic device terminal having a certain specification. In order to implement a system where the rights information and contents stored in the information recording region 18 cannot easily be acquired or copied, protection is carried out by a module of which the software is made to be tamper resistant, or a circuit of which the hardware is made to be tamper resistant.

The information recording medium 21 is attachable to and removable from the user terminal 11, and is a nonvolatile semiconductor medium that can record digital data. The information recording medium 21 and a host device have a special processing procedure for identifying that they are mutually appropriate devices. When this process is successful, a confidential region 22 becomes accessible to the recording medium 21. Here, a non-confidential region 24 is accessible without the necessity for carrying out the special processing procedure. Some media, such as SD (Secure Digital) memory cards, are provided with a high-level copyright protection function as the information recording medium 21.

A condition of storing the delivered contents is shown in the information recording region 18 of FIG. 1B. That is, the rights information 19 is stored in a rights information storage region of the information recording region 18, and contents 20 are stored in a contents storage region. On the other hand, rights information 23 is stored in the confidential region 22 which is a rights information storage region of the information recording medium 21. Contents 25 are stored in the non-confidential region 24 which is a contents storage region.

Here, FIG. 1B shows the information recording region 18 of the internal memory that stores the contents and, in addition, the information recording medium 21 that can store these contents in an external memory, within the user terminal 11 as the recording regions on the user side. However, the user terminal 11 is not provided with the information recoding region 18 that stores the delivered contents, it may have a configuration in that the contents are directly stored only in the information recording medium 21 via an IF circuit for an external memory (not shown). In contrast, the user terminal 11 is provided with the information recording region 18 as an internal memory that stores the delivered contents; however, it may not be mounted with an external memory for storing the contents, that is, the information recording medium 21. Furthermore, it is not necessary for the information recording region for storing the contents and the memory region for storing the rights information to exist in the same medium. For example, the rights information may be stored in an information memory region inside the main body of the user terminal 11, and the contents may be stored in the information recording medium 21 which is attachable to the main body of the user terminal 11. Furthermore, the plural information recording media 21 are attachable to the user terminal 11 in such a manner that the rights information is stored in one information recording medium, and the contents are stored in another information recording medium.

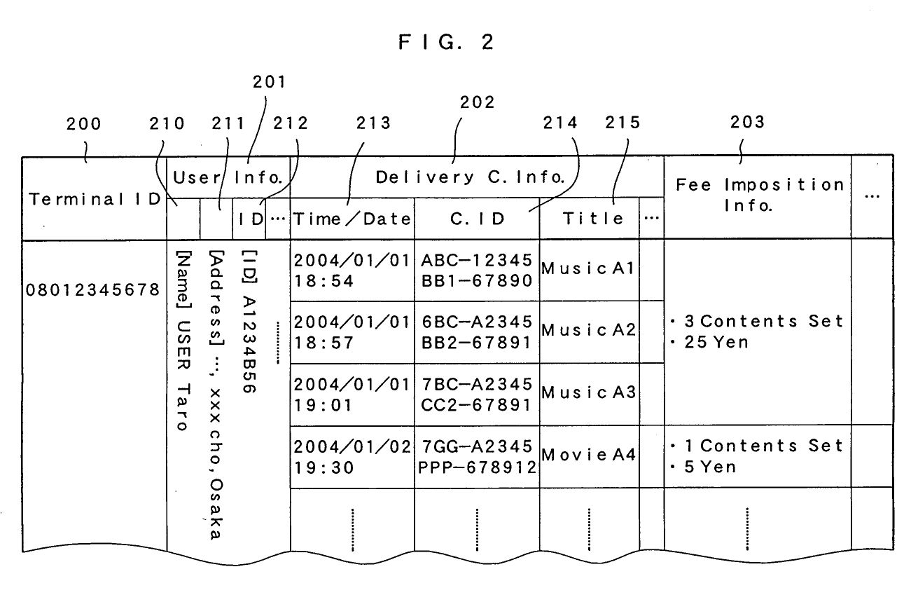

FIG. 2 is a diagram showing a concrete example of a configuration of the delivery history database 8 where the contents delivery server 3 reads in and updates the delivery history. As shown in the figure, the delivery history data has regions for storing information such as a terminal ID 200, user information 201, delivery contents information 202 and fee imposition processing information 203. The terminal ID 200 is a particular ID stored in the user terminal, and is a value that can uniquely identify the user 2, such as a telephone number in a case the user terminal is a cellular phone or a PHS. The user information 201 is information concerning the user 2 who receives contents delivery, and is formed of information such as a name 210, an address 211, and an ID 212 that is uniquely added to the user 2.

The delivery contents information 202 is information concerning contents delivered to the user 2, and is formed of information such as delivery time and date 213 when the contents are delivered, a contents ID 214 that can uniquely identify the contents, and a contents title 215 which is the name of the contents. The fee imposition information of each part of the contents where the price (fee) for the contents delivery has been carried out is described in the fee imposition processing information 203.

The contents provider 1 carries out fee settlement processing once a month on the user 2 in accordance with this fee imposition processing information through withdrawal from a bank or through credit card. More concretely, FIG. 2 shows an example where contents are delivered to the user 2 whose terminal ID is “08012345678”, whose name is “USER Taro”, whose address is “ . . . xxx-cho, Osaka”, and whose ID is “A1234B56”. The delivered contents of which the contents name is “Music A1”, for example, has the contents ID “ABC-12345 BB1-67890”, and the history of delivery that carried out at 18:54 on Jan. 1, 2004, is recorded. In addition, these delivered contents are one part of three-part contents of which the combined price is 25 yen according to the fee imposition processing information 203, wherein the contents of “Music A1” has been purchased in addition to “Music A2” and “Music A3 as a set.”

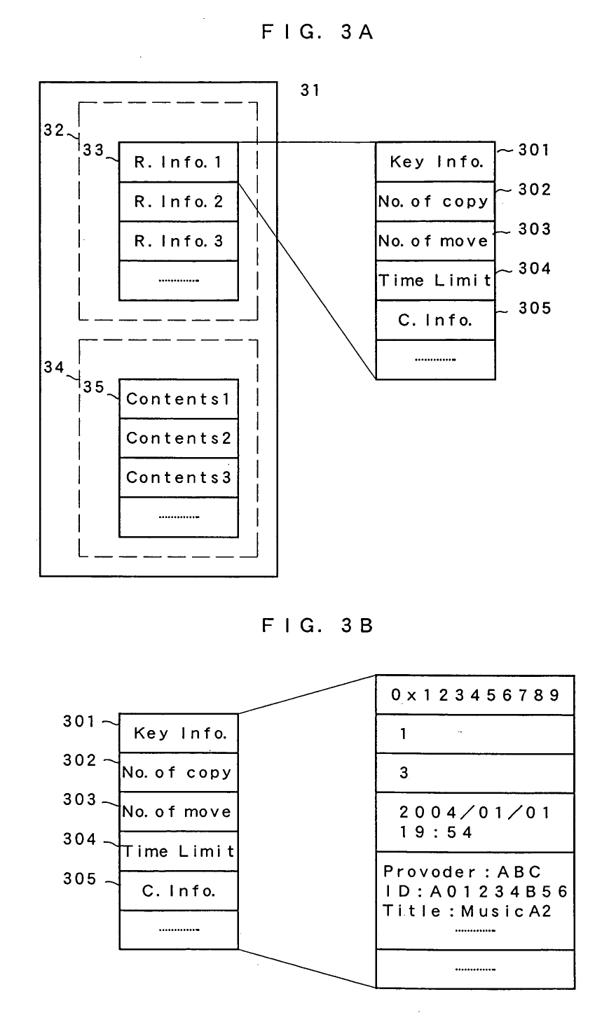

FIGS. 3A and 3B show that a confidential region 32 and a non-confidential region 34 are provided in the information recording medium 31. Here, the contents of the rights information stored in the confidential region 32 are shown as a concrete example of rights information attached to contents. FIG. 3A shows encryption key information 301, a number of allowed copies 302, a number of allowed movements 303, information on time limit on use 304, contents information 305 and the like. The encryption key information 301 is information on a key that has encrypted the contents. The number of allowed copies 302 is the number of times that the contents can be copied. The number of allowed movements 303 is the number of times that the contents can be moved to another information recording region or another information recording medium. The information on time limit on use 304 is a set value of the time limit on use of a service provided by a contents provider or a service provider. The contents information 305 is information on the contents, such as a contents provider or a service provider that has delivered the contents stored in the non-confidential region 34, the ID of the contents, the title of the contents and the like.

FIG. 3B shows a concrete example of rights information. Specifically, FIG. 3B shows an example of which the encryption key information 301 is “123456789”, of which the number of allowed copies 302 is 1, of which the number of allowed movements 303 is 3, and of which the information on time limit on use 304 is 19:54 on Jan. 1, 2004. This information on time limit on use sets a time limit on use of the service that is provided by the contents provider or the service provider concerning the contents as described above. In a case the present time is before the value of this information on time limit on use, this can be utilized for overwriting with new rights information. FIG. 3B also shows, as the contents information 305, an example of which the contents provider or the service provider is “ABC”, of which the contents ID is “A01234B56”, and of which the title of the contents is “Music A2”.

Here, the rights information 19 in the information recording region 18 of the user terminal 11 shown in FIG. 1B is formed of similar information. Furthermore, rights information is not limited to that having the configuration shown in FIGS. 3A and 3B, but rather, a part or the entirety of rights information may be stored in the non-confidential region 34 in an encrypted or non-encrypted state.

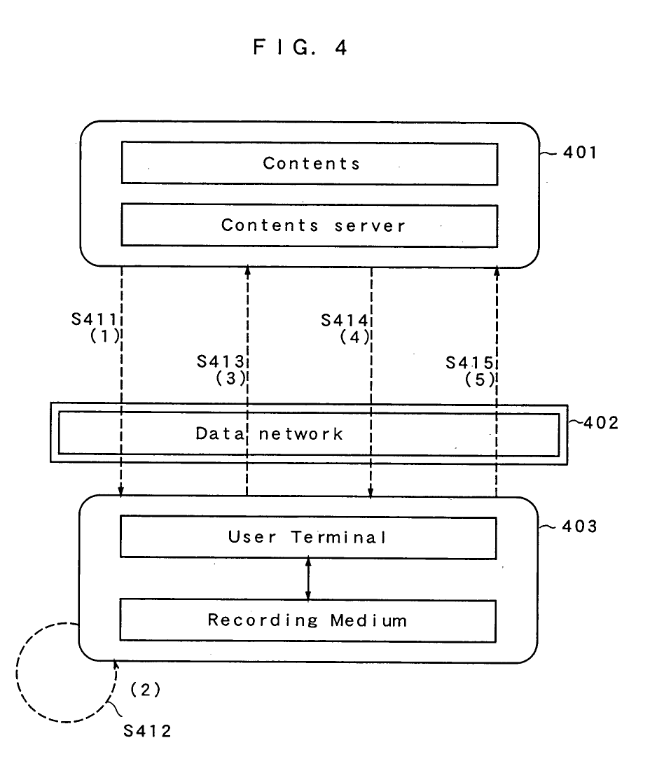

Next, a fee imposition method in the electronic contents delivery system having the above configuration will be described. FIG. 4 is a schematic diagram of a processing system for the contents delivery system shown in FIGS. 1A and 1B. A contents provider 401 is provided with the contents and the contents delivery server, and delivers rights information and contents to a user 403 via the internet network or via a data communication network 402, such as a telephone line network (step S411). The rights information and the contents that have been delivered to the user terminal of the user 403 are overwritten over the existing rights information and contents (step S412). The results of overwriting over the existing rights information and contents are transmitted to the contents provider 401 (step S413). At this time, a type of courtesy benefit fee which is different from the fee of a case of newly delivered contents is imposed (step S414). The user 403 enjoys the type of courtesy benefit fee and pays the price of the contents (step S415). In such a system, the contents provider 401 can receive the price of the delivered contents.

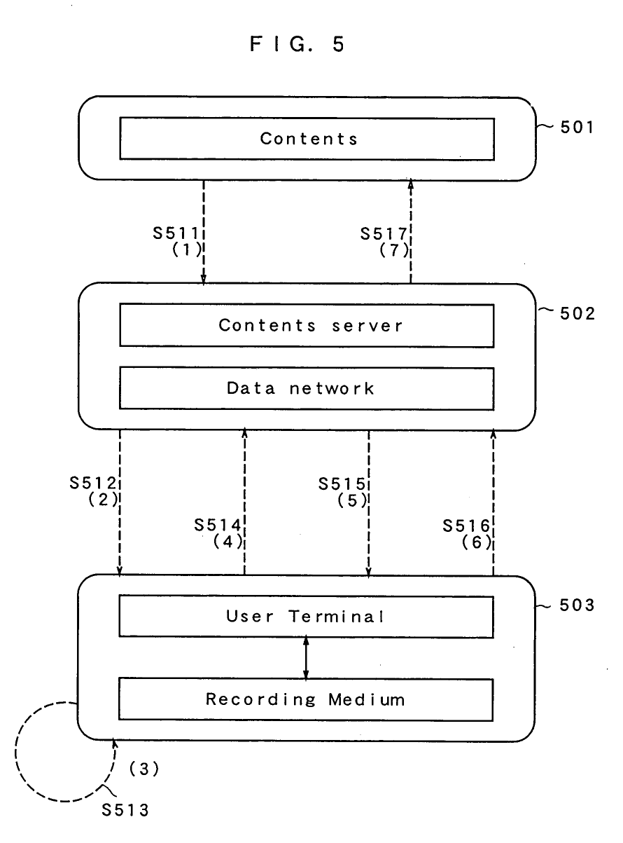

Furthermore, FIG. 5 shows a case where the contents provider that prepares the contents and the service provider are clearly separate. That service provider acquires the contents from the contents provider and delivers the contents to users. FIG. 5 shows that the contents provider 1 shown in FIG. 1 is formed as a service provider 502 including the data communication network 10. FIG. 5 further shows a processing system in a case a contents provider 501 that only delivers the contents to this service provider exists. This corresponds to a service where a company conducting, for example, cellular phone or PHS business delivers the contents that have been acquired from outside via the data communication network developed by the company itself to a user.

The contents provider 501 that holds the contents delivers or supplies contents to the service provider 502 (step S511). The service provider 502 delivers rights information and contents via a communication network in response to a request from the user 503 (step S512). The rights information and the contents that have been delivered to the user terminal of the user 503 are overwritten over the existing rights information and contents (step S513). The results of overwriting over the existing rights information and contents are transmitted to the service provider 502 (step S514). Then, a type of courtesy benefit fee (discount fee) that is different from the fee in a case of newly delivered contents is imposed (step S515).

The user 503 enjoys the type of courtesy benefit, and pays the fee for use of the communication network and the price of the contents (step S516). The service provider 502 pays the price of the contents to the contents provider 501 (step S517). In such a system, the contents provider 501 receives the price of the contents. In a case fee imposition processing is carried out on data transfer in addition to the price of the contents, the service provider 502 can receive the price of this from the user 503.

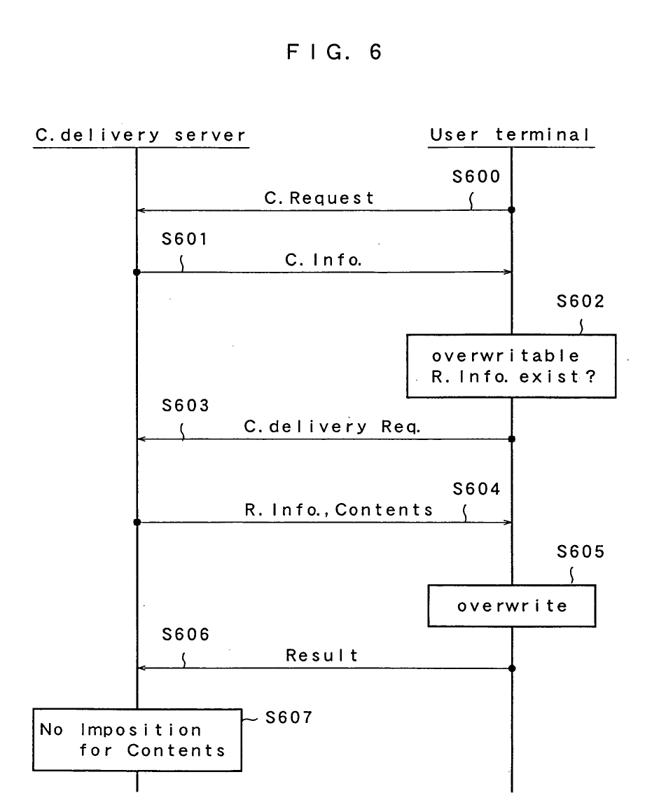

A concrete example of a delivery service method which is developed by such a contents delivery system will be further described with reference to FIG. 6. FIG. 6 is a schematic diagram showing data transmission between a contents delivery server and a user terminal. First, the user terminal is operated, so that a request for contents is transmitted to the contents delivery server (step S600). At this time, information such as the ID particular to the user terminal is transmitted together. In contrast, the contents delivery server transmits information on the requested contents, such as the contents ID, the provider ID, the size and the like, to the user terminal (step S601). When the user terminal receives the information on the contents, search is carried out in order to determine whether or not overwriting of the rights information within the terminal or within an information recording medium is possible.

As a result of this search, the same information is retrieved from provider IDs of the rights information stored within a terminal body or in an information recording medium using the provider IDs. Furthermore, as a result of this search, the same type of contents are retrieved from music contents, video contents and the like, for example, using the contents IDs. In a case overwrittable rights information is retrieved, the user is informed that the existing rights information can be overwritten with new rights information. Thus, whether or not the rights information is overwritten is received from the user (step S602).

Next, delivery of the contents and the rights information is requested to the contents delivery server by the user terminal (step S603). The contents delivery server delivers the requested contents and rights information (step S604). The existing rights information is overwritten with the delivered rights information in the user terminal (step S605), and the contents are replaced. As a result of the overwriting of the existing rights information, the rights information of the overwritten contents is transmitted to the contents delivery server (step S606). The contents delivery server confirms that the rights information stored in the user terminal has been overwritten with the new rights information from the transmitted rights information. As a result of this, the contents delivery server carries out fee imposition processing on the fee that has been discounted from the normal fee (step S607).

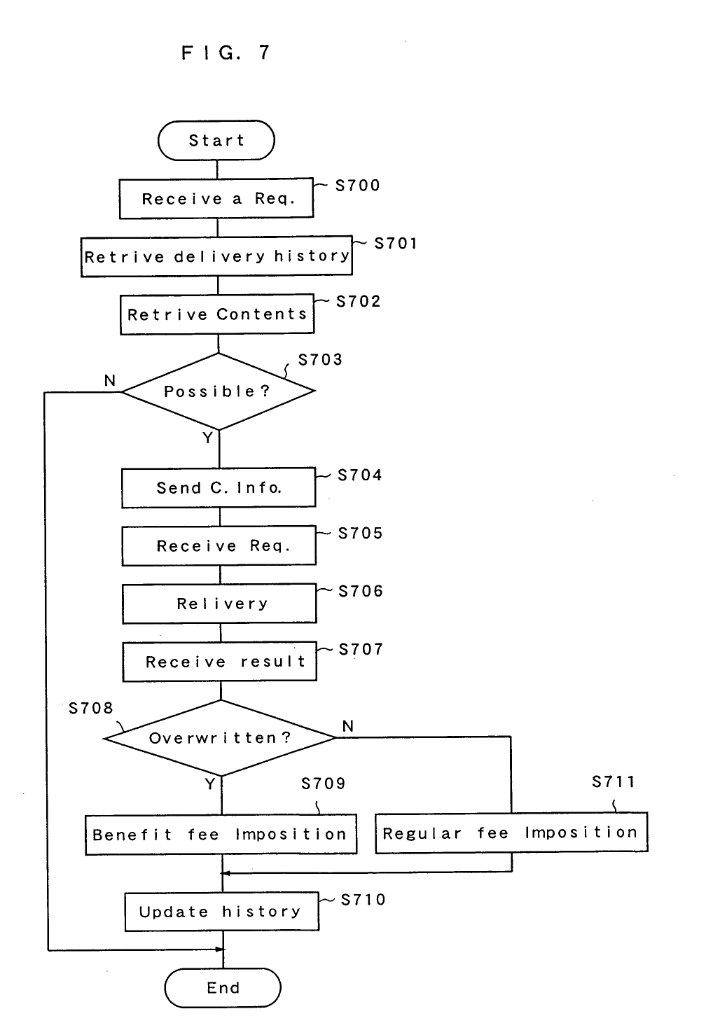

In addition, the individual operations of the contents delivery server and the user terminal will be described in detail. FIG. 7 is a flowchart showing concrete operation processing of the contents delivery server in the configuration of FIG. 1A in order to implement the processing system shown in FIGS. 4 and 5. First, the contents delivery server receives a request for the contents of which the delivery is desired from the user 503 (or 403) (step 700). At this time, the contents delivery server also receives the information of the ID particular to the terminal. Next, the contents delivery server retrieves the information on the user from the delivery history database 8 using the received ID particular to the terminal (step S701).

Next, the contents delivery server retrieves the contents for delivery corresponding to the request from the user (step S702). The contents delivery server determines whether or not delivery of the contents is possible from the delivery history and the contents for delivery to the user that have been searched as described above (step S703). This means that it determines whether or not the case corresponds to any of the matters of restriction on the individual users that have been recognized by the contents delivery server and contents delivery service side, such as stopping of service supply, specification limitation of the receiving terminal or the like. In step S703, in a case the contents delivery server determines that delivery of the contents to the user is not possible, the process of the contents delivery is completed.

In a case the contents delivery server determines that the contents delivery to the user is possible, information on the contents, such as the provider ID, the contents ID and the data size, is transmitted to the user terminal (step S704). Next, the contents delivery server receives a request for delivery of the contents from the user terminal, and carries out the delivery of the contents to the user terminal (step S705, step S706). Next, the contents delivery server receives information on the results of overwriting of the rights information and the contents in the user terminal (step S707). The contents delivery server determines whether or not the existing contents and rights information stored in the user terminal have been overwritten from the information on the results of overwriting in this user terminal (step S708).

First, in step S708, processing in a case of overwriting no existing contents and rights information will be described. In this case, the contents delivery server imposes a reqular fee for the delivered contents (step S711). Such fee imposition information is stored as the delivery history (step S710).

Next, in step S708, processing in a case the existing contents and rights information have been overwritten will be described. In this case, the contents delivery server carries out fee imposition processing on a courtesy benefit fee (step S709). Here, the courtesy benefit makes the fee imposed for the contents one that has been discounted by a certain amount from the fee in a case the above existing contents and rights information have not been overwritten; adds certain service points; delivers a variety of service coupons; and the like. Next, the delivery history is updated, including information on such a courtesy benefit (step S710). Here, at this time, the contents delivery server may record the information received from the user terminal, that is, the existing rights information that has been overwritten in the delivery history.

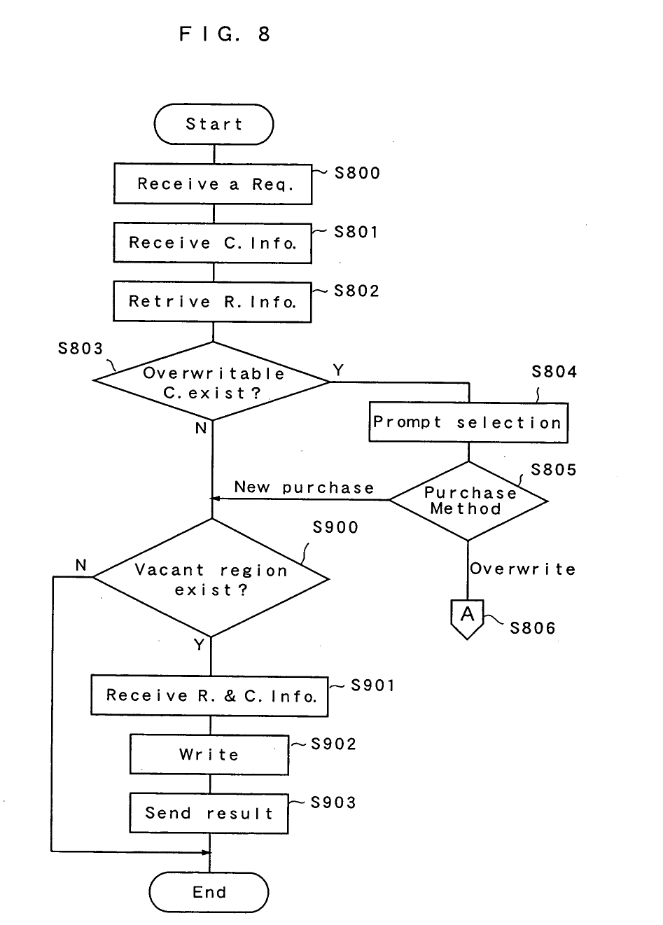

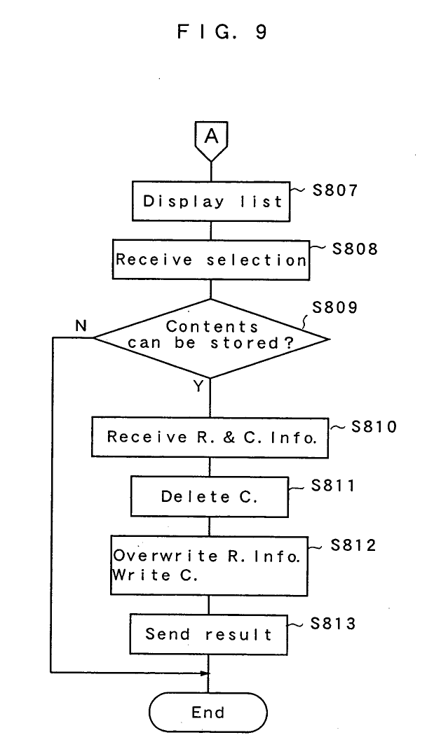

Next, concrete operation processing of the terminal will be described with reference to FIGS. 8 and 9. First, the user operates the terminal so as to select desired contents. The terminal transmits information on the selected contents to the server (step S800). At this time, the terminal transmits ID information particular to the user terminal. Next, the terminal receives information on the desired contents, such as the provider ID, the contents ID, the contents size and the like, from the server (step S801). Next, the terminal retrieves rights information stored within the terminal body or rights information stored in an information recording medium that is attachable to the terminal body (step S802). The terminal may determine that the same provider ID is found from the retrieved results and information on the received contents, and the contents are the same type using the contents IDs. It means that rights information that can be overwritten exists within the terminal body or in the information recording medium. In such a manner, the terminal determines whether or not rights information to be overwritten exists (step S803).

Here, a method for determining whether or not the number of allowed copies included in the rights information is the same as that of the contents delivered from the server may be used as the method for determining whether or not overwrittable rights information exists or not, as described above. In addition, a method for determining whether or not the number of allowed movements included in the rights information is the same as that of the contents delivered from the server may be used as the method for determining whether or not overwrittable rights information exists or not. Furthermore, a method for receiving one or more contents ID from the server so as to determine whether or not this contents ID is the same as that included in the rights information may be used as the method for determining whether or not the overwrittable rights information exists. Moreover, a method for receiving one or more title of the contents from the server so as to determine whether or not this title of the contents is the same as that included in the rights information may be used as the method for determining whether or not the overwrittable rights information exists.

First, processing in a case no overwrittable rights information exists on the rights information stored within the terminal body or in an information recording medium attachable to the terminal body will be described. In this case, the procedure proceeds through step S803 and step S804 and, then, proceeds to step S805. Steps S900 to S903 form a flowchart that shows processing in a case contents are newly purchased in step S805. Here, the terminal checks whether or not a vacant region for storing the delivered data exists in the rights information storage region and in the contents storage region within the terminal body or in the information recording medium (step S900). In a case no vacant region exists, the process is completed. On the other hand, in a case a vacant region exists, the rights information and the contents are received (step S901). The received rights information and contents are written into the inside of the terminal body or into the information recording medium (step S902). Next, the terminal transmits the results after such processing has been carried out and the rights information before overwriting to the server side (step S903).

Next, processing in a case overwrittable rights information on the rights information stored in the terminal body or in the information recording medium exists will be described (step S803). In this case, the terminal outputs a display, prompting selection of a purchase method (step S804). The user selects one of the outputted purchase methods (step S806).

In a case the user selects a process for new purchasing contents, the same process as that shown in FIG. 8 is carried out. The description of the contents of the process in this case is omitted. On the other hand, in a case a process for overwriting the existing rights information is selected in step S805, the procedure proceeds to the process shown in FIG. 9. In step S807, a list of the contents of which the rights information can be overwritten by the terminal is displayed. The terminal receives contents information that has been selected by the user from the displayed list (step S808). Next, it is verified whether or not the contents selected by the user can be stored in the terminal body or in the information recording medium (step S809). In a case it can be stored, the terminal receives rights information and contents from the server (step S810) and the contents of which the rights information are overwritten from among the existing contents are deleted (step S811).

Next, the terminal overwrites the existing rights information with the received rights information, and carries out write-in of the contents (step S812). Then, the terminal transmits the results of overwriting and the rights information before overwriting to the server (step S813). Here, though an example where the contents are received in step S810 and the existing contents are deleted in step S811 is shown, a method for first deleting the existing contents and then receiving the contents after the deletion may be possible. Furthermore, the transmission of the rights information to the contents delivery server may be carried out according to a transmission method via a safe system such as an application of an encryption process. In addition, at this time, information that can uniquely specify the erased contents may be sent in place of the rights information.

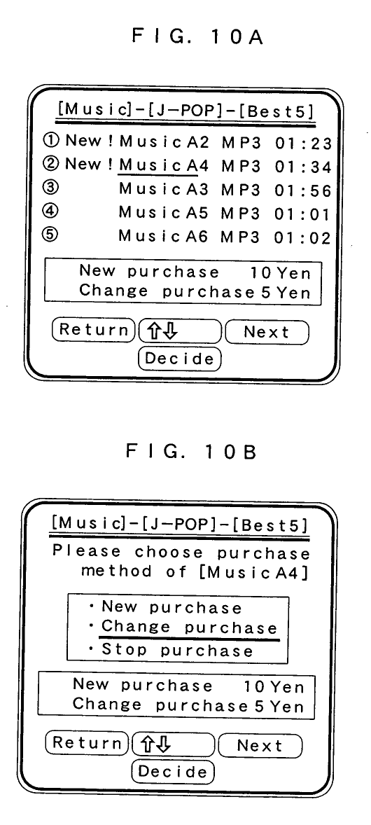

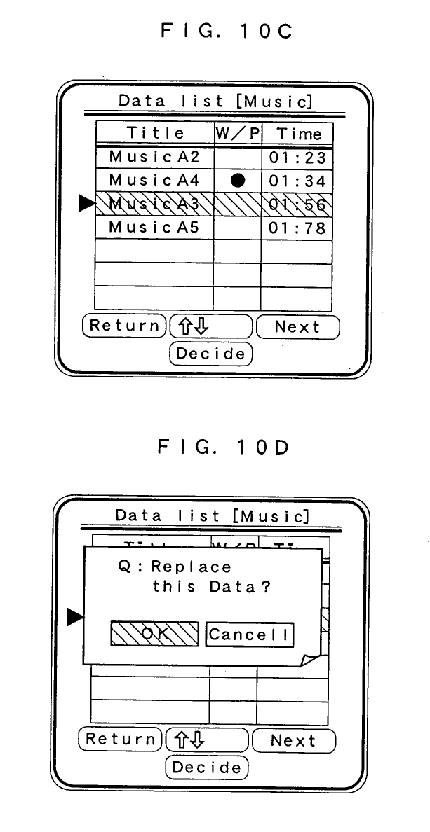

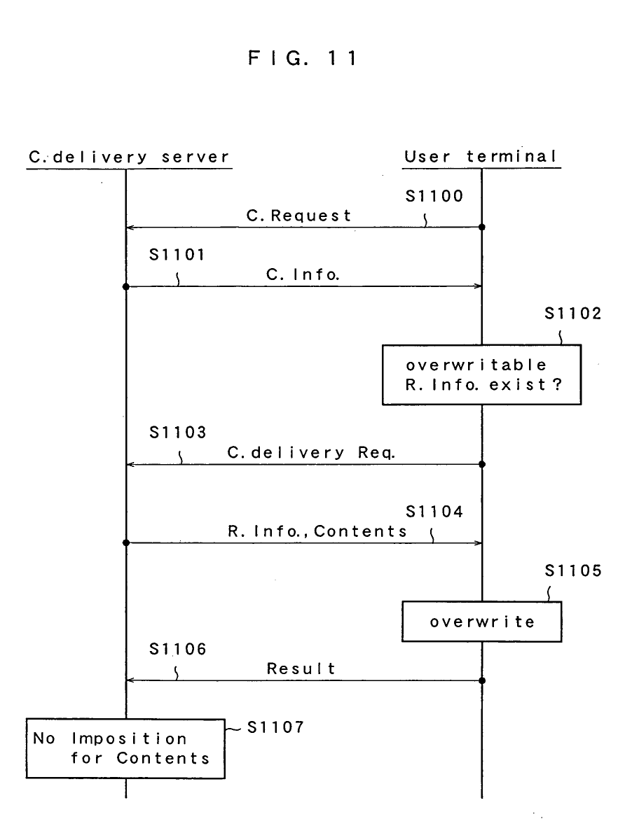

FIGS. 10A to 10D show an example of an image output on the terminal in a case the rights information in an information recording medium in or attached to the terminal is overwritten in the above process of the terminal. FIG. 10A is a screen from which a user selects contents and the user selects desired contents. FIG. 10B shows an example of a screen that is outputted in a case overwriting of the authority information can be carried out for the contents selected by the user. The indication “change purchase” in FIG. 10B shows a purchasing method in a case the existing rights information is overwritten with new rights information. In a case such a purchasing method for contents is selected, the contents can be purchased, for example, for 5 yen. On the other hand, in a case the existing rights information is not overwritten with new rights information, the contents can be purchased, for example, for 10 yen. That is, here, courtesy benefits are a discount of 5 yen. FIG. 10C shows lists of the contents of which the rights information can be overwritten in a case a purchasing method for overwriting the existing rights information with new rights information, that is, the above “change purchase” is selected. When one item of the contents displayed in these lists is selected, overwriting of rights information and contents can be carried out after undergoing inquiry as to whether overwriting of the existing rights information and the contents is to be carried out, as shown in FIG. 10D.

The above-described contents delivery according to the first embodiment allows a user to enjoy a service with courtesy benefits, such as the purchase of contents at a discounted rate, on the condition that the user overwrites the existing rights information with new rights information. Here, the following service types utilizing the function of overwriting rights information is included in the scope of the present patent.

(1) The discount rates of the prices of the contents or the ratio of the provision of service points increase in a case overwriting is carried out on rights information that has been delivered recently. In addition, they decrease in a case overwriting is carried out on rights information that has not been delivered very recently. Such a service is possible. Concretely speaking, there is a method for carrying out the above-described fee imposition processing based on the delivery history data when the delivery history of the contents delivery server is recorded. The delivery time and date data that is included in the rights information in the terminal body of the electric apparatus or in an information recording medium is transmitted to the contents delivery server. A method is considered wherein, for example, in a case the contents of which the rights information has been overwritten have rights information that has been delivered within one week, discount or service points are provided. And in case the right information has been delivered more than one week age, no discount or service points are provided. Furthermore, a service is possible in contrast to the above description, wherein the discount rates of the costs of the contents and the rates of the provision of the service points decrease in a case overwriting is carried out on the rights information that has been delivered recently, and wherein they increase in a case overwriting is carried out on rights information that has not been delivered very recently.

(2) Another service is possible, wherein book contents, for example, may be divided and delivered in installments. In this case, book contents of which the copyright has been protected are divided by and stored in the server. The book contents desired by the user are delivered, and at this time, an ID that uniquely identifies the contents is also transmitted. At the user terminal, when perusal of the delivered book contents is completed, a request for the delivery of the data of the following pages is transmitted to the server. The delivered book contents of the following pages are overwritten over the existing rights information and the existing contents. As a result of this, it becomes possible to receive contents of a large capacity, even in a case the data recording capacity of the user terminal is small.

(3) It is possible for the user to select a service of overwriting only a portion of rights information from among the rights information of the existing contents held by the user. Concretely speaking, in a case contents where the number of movements included in the rights information is “0” are purchased and held, only the rights of the number of movements “2” is sold, according to a request by the user, allowing the sale of only the number of movements of the existing contents without the contents. As a result of this, only control information that is included in rights information can be acquired by the user terminal, saving the trouble of downloading the contents again.

Here, the first embodiment shows an example of a semiconductor medium as an information recording medium which is an external memory. However, it is not limited to the semiconductor medium, but rather, another recording medium may be used, as long as it has a copyright protection function for safely storing contents having rights information. In addition, though a method for retrieving rights information that has been stored in the terminal body or in an information recording medium is shown, retrieval only of the stored rights information is of course, carried out, in a case the rights information is stored only either in a recording region within the terminal body or in an information recording medium, such as in a case there are no memory regions within the terminal, as described above. In addition, even in the configuration where rights information is stored in both a memory region within the terminal and in an information recording medium, retrieval of the rights information may be carried out only on one, providing a type where the rights information stored in only one is overwritten. Examples are shown, wherein, in a case there is data that allows overwriting of rights information from among the existing contents, it is always determined whether or not overwriting of this rights information is to be carried out. However, a method may be used wherein overwriting of rights information from among the existing contents is carried out on the condition that there are no regions in the terminal for newly storing the contents which are about to be received.

Furthermore, in this embodiment, an example is shown wherein rights information that is overwritten with new rights information is transmitted to the contents delivery server as evidence for the results of overwriting of rights information. However, a method may be used wherein both or one of the lists of rights information within the user terminal before overwriting of rights information is carried out, and of lists of rights information within the user terminal after overwriting of rights information has been carried out is transmitted to the contents delivery server. Furthermore, a safe information exchanging method including an encryption process or an identification process may be used for the exchange of rights information and the like between the contents delivery server and the user terminal.

### Second Embodiment

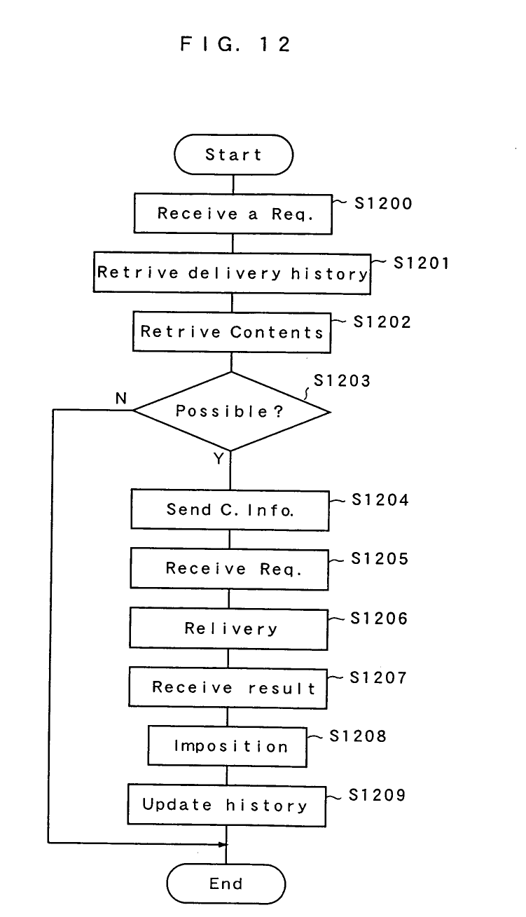

A service type in accordance with another fee imposition method in a contents delivery system will be described according to a second embodiment of the present invention. FIG. 11 is a diagram illustrating the scheme of data transmission between a contents delivery server and a user terminal according to the second embodiment.

First, the user terminal is operated, and thereby, a request for contents is transmitted to the contents delivery server (step S1100). In the contents delivery server, information on the present time is transmitted to the user terminal, in addition to information on the requested contents (step S1101). When the terminal receives the present time, search is carried out to find whether or not overwriting over the existing rights information is possible. Here, the search includes a comparison of the present time with information on limit on use that is included in the existing rights information, and a method for determining that overwriting over the existing rights information is possible in a case that the present time is before the time of information on usage rights (step S1102).

Next, delivery of the contents and the rights information is requested to the contents delivery server from the user terminal (step S1103). The contents delivery server delivers the requested contents and rights information (step S1104). At the user terminal, the existing rights information is overwritten with the delivered rights information, and the contents are replaced (step S1105). As a result of the overwriting of the existing contents, the rights information of the overwritten contents is transmitted to the contents delivery server (step S1106). The contents delivery server confirms that the rights information held by the user terminal has been overwritten with new rights information from the transmitted rights information. Then, the fee imposed on the contents that have been newly delivered is nullified (step S1107). As described above, the fee imposed on the contents is nullified within the limit of use, and thereby, services can be developed which allow sample listening of a variety of contents while maintaining the number of pieces of rights information that can be held by the user.

Next, the operations of the contents delivery server and the user terminal in a case such a service is provided will be described in detail. FIG. 12 is a flowchart illustrating a concrete operation process of the contents delivery server in a contents provider or a service provider. First, the contents delivery server receives a request from the user for contents which are desired for delivery (step S1200). At this time, information on the ID particular to the terminal is also received. Next, the contents delivery server retrieves information on the user from the delivery history using the received ID particular to the terminal (step S1201).

Next, the contents delivery server retrieves contents for delivery in response to the request from the user (step S1202). In such a manner, the contents delivery server determines whether or not the delivery of the contents is possible from the retrieved delivery history and the contents for delivery to the user (step S1203). This is the determination whether or not there is a corresponding limitation matter (stopping of service supply or specification limitation in the receiving terminal) or the like with regards to an individual user that has been recognized, for example, by the contents delivery server or on the contents delivering service side. In this step S1203, in a case it is determined that the delivery of contents is not possible, the process of contents delivery is completed. On the other hand, in a case it is determined that contents delivery is possible, the present time and the contents information are transmitted to the user terminal (step S1204). This is carried out in order to compare them with the existing rights information in the user terminal.

Next, the contents delivery server receives a request from the user terminal for delivery of the contents, and delivers the contents to the user terminal (steps S1205 and S1206). Next, the contents delivery server receives the information resulting from write-in of the rights information and contents in the user terminal (step S1207). Based on this information coming from the user terminal, the contents delivery server carries out fee imposition processing for setting the imposed fee at nothing within a constant permitted period (step S1208). Such fee imposition information is updated and stored as the delivery history (step S1209). Here, though setting of the imposed fee at nothing will be described, a method for allowing contents to become available at a very low price within a constant period of time, a method for adding service points within a constant period of time, or a method for delivering a variety of service coupons within a constant period of time may be used.

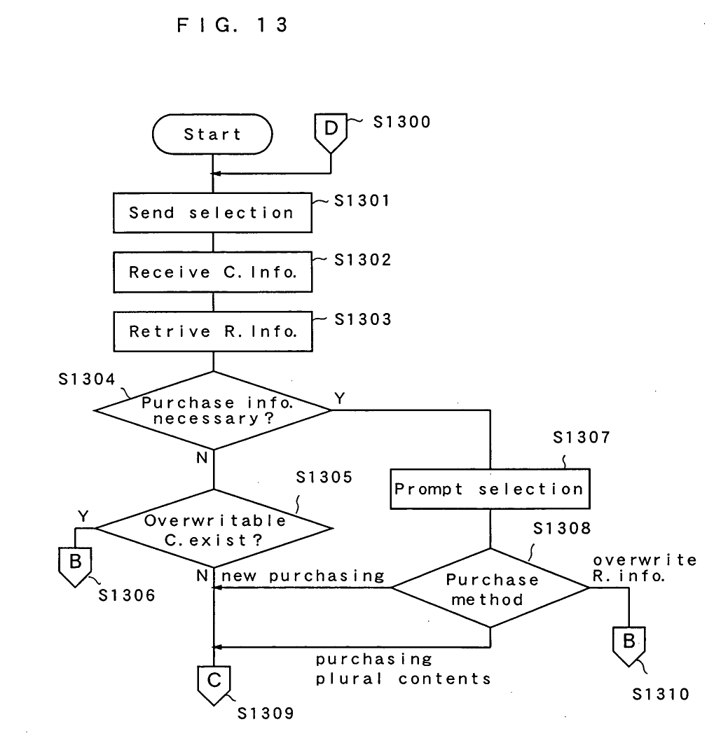

Next, a concrete operation process of the terminal will be described with reference to FIGS. 13 to 15. In FIG. 13, first, a user who operates the terminal selects desired contents and transmits information of the selected contents to the server (step S1301). At this time, the terminal also transmits ID information particular to the user terminal. Next, contents ID, use information, contents title, delivery time, provider ID, existence of fee imposition processing, information on the present time and the like, which are information concerning the desired contents, are received from the server (step S1302).

Next, rights information stored within the terminal body in the user terminal, or rights information stored in an information recording medium is retrieved (step S1303). Based on the results of the retrieval and the received contents information, the terminal determines whether or not an input display of purchase information for the user to select in what manner contents are to be purchased is necessary (step S1304). Here, the case where an input display of purchase information is not necessary is a case where fee imposition processing is not necessary for the contents selected by the user. That is, it is a case a number of items of contents are purchased as described above, and delivery of new contents is requested for a second or later time. The case where an input display of purchase information is necessary is a case other than this.

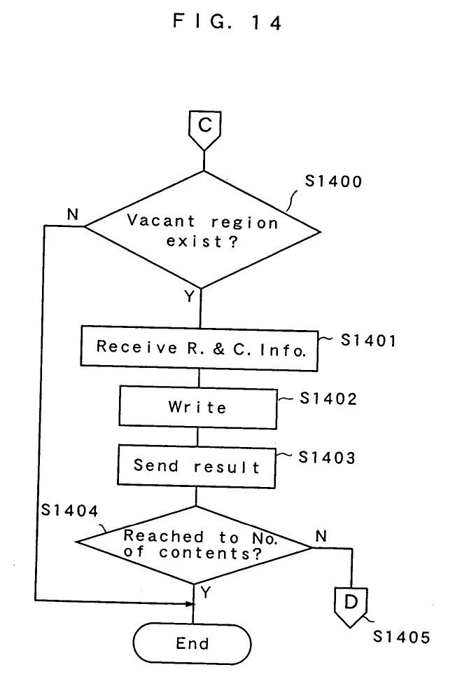

First, a case wherein an input display of purchase information is necessary in step S1304 will be described. In this case, the terminal shows a display prompting a selection of the purchase method (step S1307). Then, the terminal receives an input of the purchase method from the user (step S1308). Here, in a case a new purchase of contents is selected, the procedure goes to step S1309, where the process shown in FIG. 14 is carried out. The process of FIG. 14 (steps S1400 to S1403) is the same as the process (steps S900 to S903) shown in FIG. 8 of the first embodiment, excluding the process in and after step S1404, which will be described below.

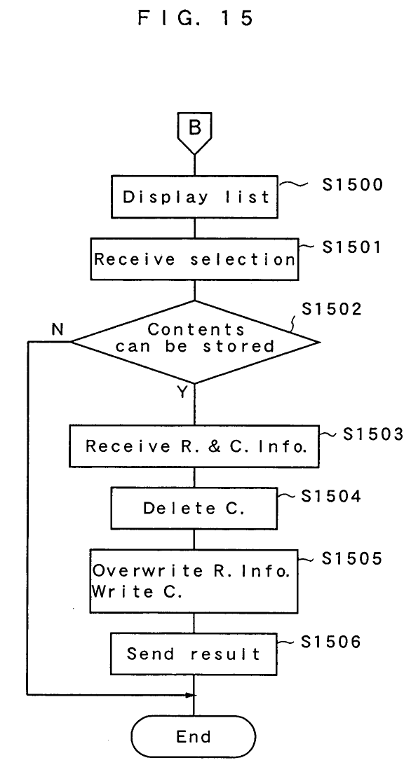

In a case overwriting of the existing rights information is selected in step S1308 of FIG. 13, the procedure goes to step S1310, and the process shown in FIG. 15 is carried out. FIG. 15 is a flowchart showing the details of step S1310 of FIG. 13. The contents of the process of FIG. 15 are the same as those of the process in steps S807 to S813 of FIG. 9 in the first embodiment; therefore, the descriptions thereof will not be given here. In a case the purchase of a number of pieces of contents is selected in step S1308 of FIG. 13, the process shown in FIG. 14 is carried out. FIG. 14 is a flowchart showing the details of steps S1309 of FIG. 13. The process in FIG. 14 has the same contents as the process in steps S900 to S903 of FIG. 8 in the first embodiment, except for that the process in step S1404 is added to the process in FIG. 14. The process here selects the purchase of a number of items of contents, and therefore, it is verified whether or not the number of items of the purchased contents will reach the limit. In a case the number of items of the purchased contents has reached the limit, the process is completed, and if it has not reached the limit, the procedure goes to step S1405, that is, the process returns to step S1300 and the following steps of FIG. 13.

Next, the case where an input display of purchase information is not necessary in step S1304 of FIG. 13 will be described. In this case, the terminal determines whether or not rights information that can be overwritten over an information recording medium in or attached to the terminal exists from the results of the search and the information concerning the received contents (step S1305). According to the determination method here, as described above, the present time received from the contents delivery server is compared with information on limit of use that is included in rights information within the information recording medium, and it is determined that rights information can be overwritten in a case the present time is before the time of the information on usage rights.

In a case rights information of the existing contents is overwritten in this step S1305, the process shown in FIG. 15 is carried out. FIG. 15 is a flowchart showing the details of step S1306 of FIG. 13. The contents of the process of FIG. 15 are the same as in steps S807 to S813 of FIG. 9 in the first embodiment; therefore, the descriptions thereof will not be given here. In a case rights information of the existing contents is not overwritten in step S1305 of FIG. 13, the process in step S1309, that is, the process shown in FIG. 14 is carried out. The process of FIG. 14 is the same as described above; therefore, the descriptions thereof will not be given here.

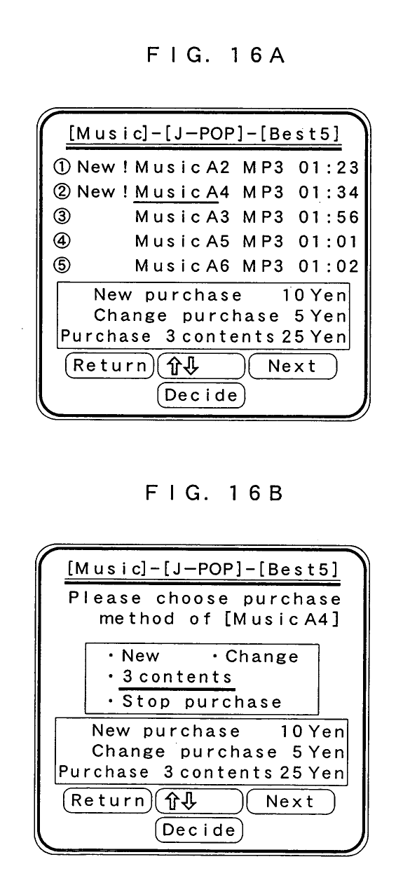

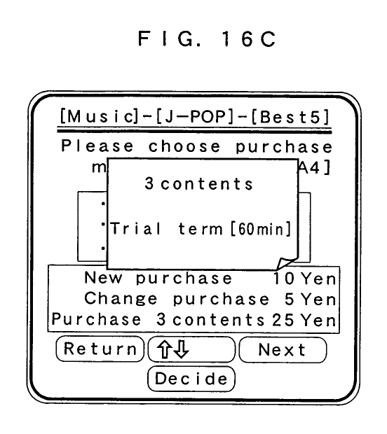

An example of a screen output on the terminal of the above process in the terminal is shown in FIGS. 16A to 16C. FIG. 16A is a screen for a user to select contents, allowing the user to select the desired contents. FIG. 16B shows an example of a screen that is outputted in a case the purchase of a number of contents items is possible from the contents that have been selected by the user. In FIG. 16B, indication “3 contents” shows that three items of contents can be purchased for 25 yen. When the user makes a selection as described above, a display is outputted which allows reception of three items of contents as many times as possible within 60 minutes, as shown in FIG. 16C.

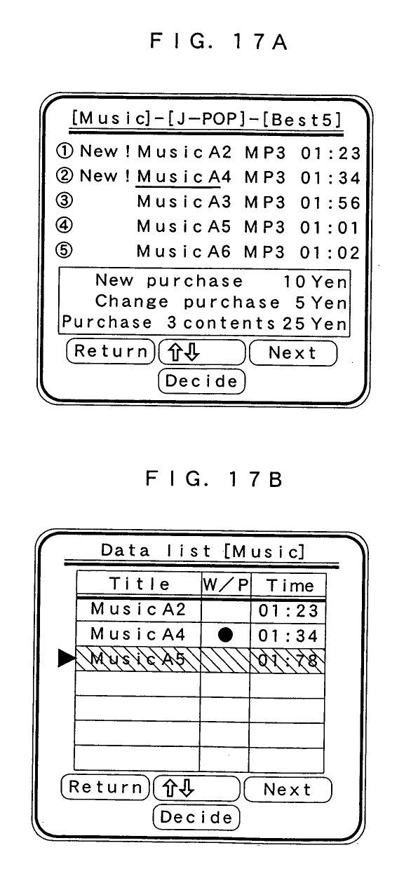

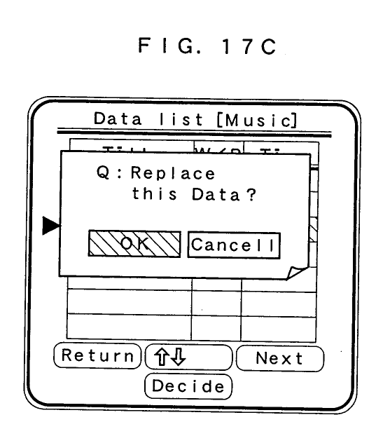

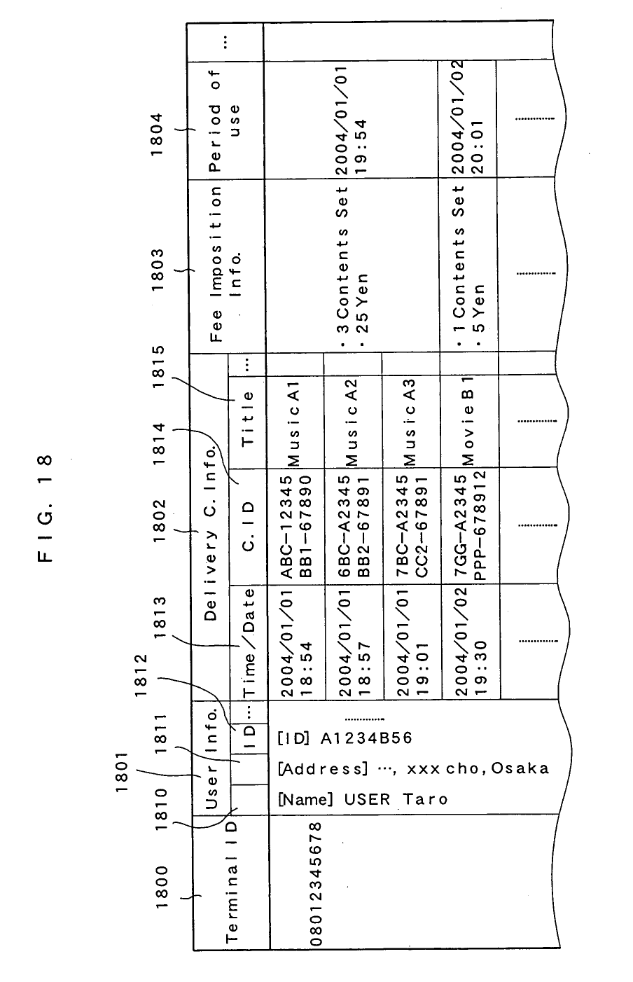

FIGS. 17A to 17C show an example of a screen when contents that come after the third item of the contents are acquired in a case the purchase of a number of items of contents is selected, as in FIGS. 16A to 16C. FIG. 17A is a screen for the user to select contents, allowing the user to select the desired contents. FIG. 17B shows a list of contents that correspond to the period of time for sample listening in a case of a purchase of a plurality of contents items from among the existing contents. The user can overwrite the existing rights information and contents with new rights information and contents during the period of time for sample listening. FIG. 17C shows a display in a case contents which are to be overwritten with new rights information are selected from among the existing contents.

As described above, according to the contents delivery method of the second embodiment, it is possible for the user to acquire only the contents that they liked after sample listening to several items of contents, on the condition that the existing rights information is overwritten with new rights information. Here, the following service types are included in the concepts of the present invention as service types for allowing only the contents that the user likes to be gained after sample listening of the contents.

(1) FIG. 18 is a diagram showing an example of the delivery history provided with the contents delivery server. The terminal ID 1800 to the contents title 1815 in the figure, excluding the period of use 1804, have the same contents as those shown in FIG. 2 of the first embodiment; therefore, the descriptions thereof will not be given here. The period of use 1804 is a value that is utilized to indicate a period of time during which the contents delivering service can be utilized. This is a value that is set in accordance with the type of the contents, and this period of time allows free delivery on the condition that rights information is overwritten.

For example, it is shown that the user of terminal ID “08012345678” has purchased a set of three items of the contents “music A1”, “music A2” and “music A3” for 25 yen. The period of use concerning these pieces of contents is shown as “2004/01/01 19:54”. Here, services provided by the service provider can be enjoyed until time 19:54 on Jan. 1, 2004, as long as the number of the items of the contents is three, without being limited to the above contents, wherein it is possible for the user of terminal ID “08012345678” to download the contents as many times as desired. As described above, it is also possible to determine whether or not the rights information of contents can be overwritten on the contents delivery server side in response to a contents request from the user terminal and, then, to deliver information on these contents to the user terminal.

(2) It is also possible to provide sample listening service of the contents with a limitation in the number of sample listening, in addition to a simple usage of time information. Concretely speaking, a method for limiting the number of times that overwriting can be carried out is possible by providing the existing rights information with a counter value, not shown, so that the counter value decreases whenever the rights information is overwritten. Furthermore, the number of times that overwriting can be carried out is managed by the delivery history, which is managed by the contents delivery server, making it possible to limit the number of times that overwriting can be carried out. Furthermore, it is also possible to use a method that utilizes both settings of the number of times that contents can be received resulting from the above-described number of times that overwriting can be carried out, and settings of time limitation of use. Here, a particular method for managing the number of times that overwriting can be carried out in the contents delivery server and in the user terminal may be a method for transmitting the numeral at the stage before the number of overwriting is overwritten and the numeral at the stage after the number of overwriting has been overwritten to the contents delivery server from the user terminal.

(3) It is possible to make the condition of the contents which are delivered during a sample listening period lack information in comparison with the contents which are delivered in their original forms. In a case of music contents, for example, data of which the data size becomes small at a low bit rate in comparison with the contents which are delivered in their original forms, not shown, and thereby, delivery in a shorter period of time becomes possible. In addition, it is also possible to implement a contents delivery system wherein the contents which have finally been acquired by the user during the sample listening period can be delivered again with their original bit rates after the completion of the sample listening period.

Here, though in the second embodiment, an example of a semiconductor medium is shown as an information recording medium which is an external memory, other recording media with a copyright protection function for safely storing the contents having rights information may be used without being limited to a semiconductor medium. Furthermore, a method for retrieving rights information that has been stored within the terminal body or in an information recording medium which is attachable to the terminal body is shown in the second embodiment. However, in the same manner as the configuration shown in FIG. 1 of the first embodiment, only the stored rights information is retrieved in a case rights information is stored in only one of a memory region within the terminal body or an information recording medium that is attachable to the terminal body, such as in a case there is no memory region within the terminal body.

In addition, even in a case rights information is stored in both a memory region within the terminal body and in an information recording medium, a method may be used wherein rights information stored in only one is retrieved, and overwriting of rights information stored in only one is carried out. Furthermore, in this embodiment, an example is shown wherein rights information which is to be overwritten with new rights information is transmitted to the contents delivery server, as evidence showing the results of overwriting of rights information. However, a method may be used wherein both or one of the lists of rights information within the user terminal before overwriting of rights information is carried out, and of lists of rights information within the user terminal after overwriting of rights information has been carried out is transmitted to the contents delivery server. In addition, a method for transmitting information that can uniquely identify the erased contents may be used. Furthermore, a secure information exchanging method, including an encryption process or an identification process, may be used for the exchange of rights information or other information between the contents delivery server and the user terminal in this embodiment. In addition, a method may be used wherein services shown both in the first and second embodiments may be used.

In accordance with a contents delivery method and in a contents delivery system according to the present invention, a user can freely take in the contents that the user wants to enjoy, due to free or discounted rates in a case the delivered contents are overwritten in an electronic device terminal or in an information recording medium. In addition, the contents provider develops a variety of services, and thereby, distribution of the contents can be increased. Such a contents delivery method and contents delivery system can be appropriately utilized by a contents provider for cellular phones, and can be actively utilized by a cellular phone service company having a contents database. In either case, the amount of data transmission through data communication networks increases; therefore, excellent economic effects are brought to line infrastructure sectors that lay and manage lines.

It is to be understood that although the present invention has been described with regard to preferred embodiments thereof, various other embodiments and variants may occur to those skilled in the art, which are within the scope and spirit of the invention, and such other embodiments and variants are intended to be covered by the following claims.

The text of Japanese priority application No. 2003-416300 filed on Dec. 15, 2003 is hereby incorporated by reference.

1. A contents delivery method for delivering contents to an electronic device terminal free of charge or at a discounted rate on a basic condition that rights information stored in a body of said electronic device terminal or in an information recording medium attached to the body of said electronic device terminal is overwritten with newly delivered rights information in a case said electronic device terminal has a function of storing contents and a function of storing rights information including information on limitation of use or information on an encryption key of said contents, when a contents delivery server delivers the rights information and the contents which are made up of digital data to said electronic device terminal via a data communication network under a condition of fee imposition in response to a request for contents delivery from said electronic device terminal.

2. A contents delivery method according to claim 1, wherein
said rights information and the contents corresponding to said rights information are stored in different information recording media.

3. A contents delivery method according to claim 1, wherein
said electronic device terminal receives said contents free of charge or at a discounted rate under said basic condition in a case it can be determined under a particular condition that contents information concerning a contents which are newly purchased from said contents delivery server and contents information that is managed by said electronic device terminal are substantially the same.

4. A contents delivery method according to claim 3, wherein
said particular condition includes information that can uniquely identify a contents delivery service provider.

5. A contents delivery method according to claim 1, wherein
said electronic device terminal receives said contents free of charge or at a discounted rate under said basic condition in a case the rights information concerning the contents which are newly purchased from said contents delivery server and the information on limitation of use for limiting the use of the contents that is included in the rights information managed by said electronic device terminal are substantially the same.

6. A contents delivery method according to claim 5, wherein
said information on limitation of use includes the number of copies of said contents to be copied or the number of movements of said contents to be moved.

7. A contents delivery method according to claim 1, wherein
a fee is imposed under said basic condition in a case only information on limitation of use of the contents that is included in said rights information on said contents is updated.

8. A contents delivery method according to claim 1, wherein
said contents delivery server retrieves a request for contents delivery from said electronic device terminal, the past rights information held by said contents delivery server and a delivery history of the contents, and transmits a list of the rights information that can be overwritten with newly delivered rights information to said electronic device terminal, and said electronic device terminal receives said contents free of charge or at a discounted rate under said basic condition.

9. A contents delivery method according to claim 1, wherein
said electronic device terminal receives said contents free of charge or at a discounted rate under said basic condition in a case an available region in the information recording medium in or attached to said electronic device terminal is short for rights information and contents to be newly written into and in a case at least one piece of rights information exists.

10. A contents delivery method according to claim 1, wherein
said electronic device terminal receives said contents free of charge or at a discounted rate under said basic condition in a case said contents are received before a predetermined set period of time has passed since the time of delivery of the previous rights information.

11. A contents delivery method according to claim 10, wherein
said predetermined set period of time has a value that is calculated from a comparison between time information delivered from said contents delivery server and time information included in said rights information.

12. A contents delivery method according to claim 1, wherein
said electronic device terminal receives said contents free of charge or at a discounted rate under said basic condition in a case the number of deliveries of contents since the time of delivery of the previous rights information is within a predetermined number.

13. A contents delivery method according to claim 1, wherein
said contents delivery server determines the discounted rate of said contents on the basis of time and date information that has been delivered from said contents delivery server in a case said rights information stored in the body of said electronic device terminal or in said information recording medium includes said time and date information.

14. A contents delivery method according to claim 1, wherein
said contents delivery server provides a variety of point services and a variety of coupon information to said electronic device terminal under said basic condition.

15. A contents delivery method according to claim 1, wherein
in a case a variety of point services and variety of coupon information are provided to said electronic device terminal under said basic condition, said contents delivery server determines provision of said variety of point services and said variety of coupon information on the basis of time and date information that has been delivered from said contents delivery server, when said rights information stored in said information recording medium in or attached to said electronic device terminal includes said time and date information.

16. A contents delivery system comprising:
a contents delivery server which delivers contents made up of digital data;
a data communication network which transmits and receives data using a wired or wireless communication line; and
an electronic device terminal which has a function of storing contents and a function of storing rights information that includes information on limitation of use or information on an encryption key concerning said contents, wherein
when said contents delivery server delivers rights information and contents to said electronic device terminal via said communication network under a condition of fee imposition in response to a request for contents delivery from said electronic device terminal, said contents delivery server carries out processing of making the fee free of charge or processing of making the fee a discounted rate and delivers said contents to said electronic device terminal on a basic condition that said rights information that has been stored in an information recording medium in or attached to said electronic device terminal is overwritten with newly delivered rights information.

17. A contents delivery system according to claim 16, wherein
said rights information and the contents corresponding to said rights information are recorded in different information recording media.

18. A contents delivery system according to claim 16, wherein
said electronic device terminal retrieves the rights information of the contents that can be determined under a specific condition to be substantially the same as the contents information on the contents which are newly purchased, from an information recording medium in or attached to said electronic device terminal, and overwrites the retrieved rights information with the newly delivered rights information, and
said contents delivery server delivers said contents to said electronic device terminal after the overwriting of said rights information.

19. A contents delivery system according to claim 18, wherein
said specific condition includes information that can uniquely identify a contents delivering service provider.

20. A contents delivery system according to claim 16, wherein
said electronic device terminal retrieves information on limitation of use that is included in the rights information concerning said newly purchased contents and information on limitation of use of said contents corresponding to rights information stored in an information recording medium in or attached to said electronic device terminal to see whether or not the two pieces of said information on limitation of use are the same, and overwrites said rights information with the newly delivered rights information in a case the two pieces of said information on limitation of use are the same, and
said contents delivery server delivers said contents to said electronic device terminal after the overwriting of said rights information.

21. A contents delivery system according to claim 20, wherein
said information on limitation of use is the number of copies of the corresponding contents to be copied or the number of movements of the corresponding contents to be moved.

22. A contents delivery system according to claim 16, wherein
said electronic device terminal overwrites information on limitation of use for limiting the use of said contents which is included in said rights information in the information recording medium in or attached to said electronic device terminal, and
said contents delivery server carries out fee imposition processing on said contents and delivers said contents to said electronic device terminal in a case the existing information on limitation of use is overwritten with said newly delivered information on limitation of use.

23. The contents delivery system according to claim 16, wherein
said contents delivery server holds a delivery history of the rights information and the contents which have been delivered in the past and retrieves rights information from said delivery history on the basis of a request for contents delivery from said electronic device terminal, thereby generating a retrievable list of rights information that can be overwritten with said new rights information,
said electronic device terminal receives said retrievable list which has been delivered from said contents delivery server and retrieves the corresponding rights information in the received retrievable list from the rights information stored in an information recording medium in or attached to said electronic device terminal so as to overwrite said retrieved rights information with the newly delivered rights information, and
said contents delivery server delivers said contents to said electronic device terminal after the overwriting of said rights information.

24. A contents delivery system according to claim 16, wherein
said electronic device terminal overwrites the existing rights information that has been stored in the information recording medium in or attached to said electronic device terminal with said newly delivered rights information in a case it is detected that an available region in said information recording medium in or attached to said electronic device terminal is short for the newly delivered rights information and contents to be written into, and
said contents delivery server delivers said contents to said electronic device terminal after the overwriting of said rights information.

25. A contents delivery system according to claim 16, wherein
the contents delivery server determines whether or not the time of delivery of the new rights information is within a predetermined time period from the delivery time of the previous rights information, and delivers said contents to said electronic device terminal after the overwriting of said rights information in a case of being within said predetermined time period.

26. A contents delivery system according to claim 25, wherein
said predetermined time period has a value calculated from a comparison between time information delivered from said contents delivery server and time information stored in said rights information.

27. A contents delivery system according to claim 16, wherein
the contents delivery server determines whether or not the number of deliveries of the new rights information is within a predetermined number of deliveries from the time of delivery of the previous rights information, and delivers said contents to said electronic device terminal after the overwriting of said rights information in a case of being within said predetermined number.

28. A contents delivery system according to claim 16, wherein
the discounted rate of said contents is determined by using time and date information when new rights information is delivered from said contents delivery server to said rights information stored in said information recording medium in or attached to said electronic device terminal.

29. A contents delivery system according to claim 16, wherein
said contents delivery server carries out fee imposition processing including the discount of the fee on said electronic device terminal on the basis of information on a variety of point services and a variety of coupons.

30. A contents delivery system according to claim 16, wherein
said contents delivery server provides information on a variety of point services and a variety of coupons to said electronic device terminal on the basis of time and date information that has been delivered from the contents delivery server in a case said rights information stored in said information recording medium in or attached to said electronic device terminal includes said time and data information.

31. An electronic device terminal comprising:
a rights information overwriting processing part which overwrites rights information stored in an information recording medium in or attached to the electronic device terminal with rights information that is newly delivered from a contents delivery server; and
a terminal communication processing part which transmits results of the overwriting of said existing rights information with said newly delivered rights information to said contents delivery server, wherein
when said rights information and said contents are delivered from said contents delivery server via said communication network under a condition of fee imposition in response to a request for contents delivery, said contents are received free of charge or at a discounted rate in a case of overwriting.

32. An electronic device terminal according to claim 31, wherein
said rights information overwriting processing part retrieves the rights information of the contents that can be determined under a particular condition to be substantially the same as the contents information received from said contents delivery server, and overwrites said retrieved rights information with the newly delivered rights information.

33. An electronic device terminal according to claim 32, wherein
said rights information overwriting processing part retrieves the rights information of said contents by using information that can uniquely identify a contents delivery service provider.

34. An electronic device terminal according to claim 31, wherein
said rights information overwriting processing part retrieves the information on limitation of use that is included in the rights information concerning the contents purchased from said contents delivery server and the information on limitation of use that is included in said existing rights information to see that the two pieces of information are the same, and overwrites said existing rights information, of which the information on limitation of use is the same as that of the newly delivered rights information, with the newly delivered rights information.

35. An electronic device terminal according to claim 34, wherein
said information on limitation of use is the number of copies of said contents to be copied or the number of movements of said contents to be moved.

36. An electronic device terminal according to claim 31, wherein
said rights information overwriting processing part overwrites the information on limitation of use for said contents, which is included in said existing rights information that has been received from said contents delivery server, with the information on limitation of use that is included in the newly delivered rights information.

37. An electronic device terminal according to claim 31, wherein
said rights information overwriting processing part retrieves the rights information stored in the information recording medium in or attached to said electronic device terminal, determines whether or not the retrieved rights information agrees with the rights information of the contents received from said contents delivery server, and overwrites the retrieved rights information with the newly delivered rights information including information on limitation of use in a case the two pieces of the rights information are same.

38. An electronic device terminal according to claim 31, wherein
said rights information overwriting processing part overwrites said existing rights information with the newly delivered rights information including information on limitation of use in a case it is detected that an available region in the information recording medium in or attached to said electronic device terminal is short for the newly delivered rights information and contents to be written into.

39. An electronic device terminal according to claim 31, wherein
said rights information overwriting processing part determines whether or not the time of delivery of said newly delivered rights information is within a predetermined period of time from the time of delivery of the previous rights information, and overwrites said rights information stored in the information recording medium in or attached to said electronic device terminal with the newly delivered information on limitation of time in a case the time of delivery is within the predetermined time of period.

40. An electronic device terminal according to claim 39, wherein
said rights information overwriting processing part determines whether or not the time of delivery is within the predetermined period of time from a comparison between time information delivered from said contents delivery server and time information included in said rights information stored in said information recording medium.

41. An electronic device terminal according to claim 39, wherein
said rights information overwriting processing part determines whether or not the number of deliveries of said newly delivered rights information is within a predetermined number from the time of delivery of the previous rights information, and overwrites said rights information stored in the information recording medium in or attached to said electronic device terminal with the newly delivered information on limitation of use in a case the number of deliveries is within the predetermined number.

42. A contents delivery server comprising:
a fee imposition information processing part which carries out processing of making a fee free of charge or processing of making a fee a discounted rate on an electronic device terminal at the same time as receiving processing results of overwriting of rights information from said electronic device terminal when said rights information and contents are delivered to said electronic device terminal via a communication network in response to a request for contents delivery from said electronic device terminal under a fundamental rule where processing of fee imposition is carried out on a user of said electronic device terminal that delivers the contents.

43. A contents delivery server according to claim 42, comprising:
a delivery history database which stores a delivery history of said contents;
a rights information generating part which prepares rights information of said contents; and
a server communication processing part which transmits data including contents and rights information to said electronic device terminal, wherein
said rights information generating part retrieves, using said delivery history, the rights information that can be overwritten with new rights information from among the rights information stored by said electronic device terminal, and transmits the retrieval results to said electronic device terminal via said server communication processing part, and
said fee imposition information processing part receives the results of the overwriting of said rights information from said electronic device terminal, and carries out processing of making the fee free of charge or processing of making the fee a discounted rate.

44. A contents delivery server according to claim 42, comprising:
a rights information generating part which prepares rights information of said contents; and
a server communication processing part which transmits data including contents and rights information to said electronic device terminal, wherein
said rights information generating part transmits information on limitation of use for limiting the use of said contents included in said rights information to said electronic device terminal via said server communication processing part, and
said fee imposition information processing part receives results of the overwriting of said information on limitation of use from said electronic device terminal, and carries out fee imposition processing.

45. A contents delivery server according to claim 44, wherein
the information on limitation of use that is delivered by said contents delivery server is the number of copies of said contents to be copied or the number of movements of said contents to be moved.

46. A contents delivery server according to claim 42, comprising:
a rights information generating part which prepares rights information of said contents; and
a server communication processing part which transmits data including contents and rights information to said electronic device terminal, wherein
said rights information generating part generates information on limitation of use by making predetermined time information included in said rights information, and transmits the information on limitation of use to said electronic device terminal via said server communication processing part, and
said fee imposition information processing part receives the results of the overwriting of said information on limitation of use from said electronic device terminal, and carries out processing of making the fee free of charge or processing of making the fee a discounted rate.

47. A contents delivery server according to claim 42, wherein
said fee imposition information processing part receives the results of the overwriting of said rights information from said electronic device terminal, and carries out processing of providing information on a variety of point services and a variety of coupons.
